(19) United States
(12) Patent Application Publication
(10) Pub. No.: US 2009/0050783 A1
(43) Pub. Date: Feb. 26, 2009

(54) Adjustable die assembly

(75) Inventor: Donald A. Roberts, Uhrichsville, OH (US)

Correspondence Address: SAND & SEBOLT, AEGIS TOWER, SUITE 1100, 4940 MUNSON STREET, NW, CANTON, OH, 44718-3615, US

(73) Assignee: REYMOND PRODUCTS INTERNATIONAL, INC., Midvale, OH (US)

(21) Appl. No.: 11/894,971

(22) Filed: Aug. 22, 2007

(51) Int. Cl. B29C 47/12; B28B 7/02

(52) U.S. Cl. 249/155

(57) ABSTRACT

An adjustable die assembly used in the extrusion of ceramic brick-forming material includes an adjustable die which is removable for maintenance without changing the size of the die aperture. An access opening is provided for accessing a fastener which mounts the die so that the fastener may be loosened without affecting the die adjustment.

### BACKGROUND OF THE INVENTION

1. Technical Field

The present invention relates generally to a die assembly used in an extrusion process. More particularly, the invention relates to a die assembly used in the formation of ceramic bricks. Specifically, the invention relates to such a die assembly which is adjustable.

2. Background Information

It is well known to use the process of extrusion in the field of ceramic brick making. Various types of die assemblies have been used in providing the final shape of the extruded brick material, which is subsequently heated or fired to high temperatures to form bricks. Depending on the specific composition of the raw brick-forming material used to form a brick and the type of brick which is desired as a final product, the size of the aperture of the die will often be different. As a result, adjustable die plates have been developed in order to allow for the adjustment of the die aperture. However, in order to perform maintenance on certain portions of the die assembly, the partial disassembly of the die assembly has caused the die plates forming the aperture to shift so that they must be repositioned after reassembling to set the proper aperture. Readjustment of the die plates is time consuming. Applicant's invention addresses this problem.

### BRIEF SUMMARY OF THE INVENTION

The present invention provides an adjustable die assembly for extruding brick-forming material therethrough, the assembly comprising: a first base plate; a hole formed in the first base plate; a fastener in the hole; a through passage formed in the first base plate; an adjustable die adjacent the passage; a brick-forming extrusion aperture formed in the die and adapted for defining a cross sectional shape of ceramic brick-forming material extruded therethrough; an adjustable jaw on the die bounding the aperture and movable to a plurality of positions to adjust the size of the aperture; a securing member for selectively securing the jaw at a first one of the positions to set the size of the aperture; and an access opening formed through the securing member for accessing the fastener.

The present invention also provides an adjustable die assembly for extruding brick material therethrough, the assembly comprising: a base plate; first and second threaded holes formed in the base plate; a third hole formed in the base plate between the first and second threaded holes; a fastener in the third hole; an adjustable die mounted on the base plate; a brick-forming extrusion aperture formed in the die and adapted for defining a cross sectional shape of ceramic brick-forming material extruded therethrough; an adjustable jaw on the die bounding the aperture and movable to a plurality of positions to adjust the size of the aperture; first and second lock screws threadedly engaging the base plate respectively within the first and second threaded holes for selectively securing the jaw at a first one of the positions to set the size of the aperture; and an access opening between the lock screws for accessing the fastener.

The present invention further provides a method comprising the steps of: inserting a tool through an access opening formed through a securing member which secures an adjustable jaw bounding a ceramic brick-forming extrusion aperture formed in a die to engage a fastener with the tool; and loosening the fastener with the tool to remove the die from a first base plate without changing the size of the aperture.

### BRIEF DESCRIPTION OF THE SEVERAL VIEWS OF THE DRAWINGS

FIG. 1 is an exploded perspective view of the adjustable die assembly of the present invention.

FIG. 2 is front elevational view of the die assembly showing the die plates at a first setting.

FIG. 3 is a sectional view taken on line 3-3 of FIG. 2.

FIG. 4 is similar to FIG. 2 and shows the die plates having been moved to a second position in which they are further apart from one another.

FIG. 5 is a sectional view taken on line 5-5 of FIG. 4.

FIG. 6 is sectional view taken on line 6-6 of FIG. 4 and further includes a hex wrench inserted through an access opening in the upper adjusting plate to engage the upper mounting bolt.

FIG. 7 is similar to FIG. 6 and shows rotation of the hex wrench and bolt to remove the bolt from the rear base plate.

FIG. 8 is similar to FIG. 7 and shows the wrench removing the lower mounting bolt.

FIG. 9 is similar to FIG. 8 and shows the front portion of the die assembly having been removed from the rear portion to access the gasket that fits therebetween.

### DETAILED DESCRIPTION OF THE INVENTION

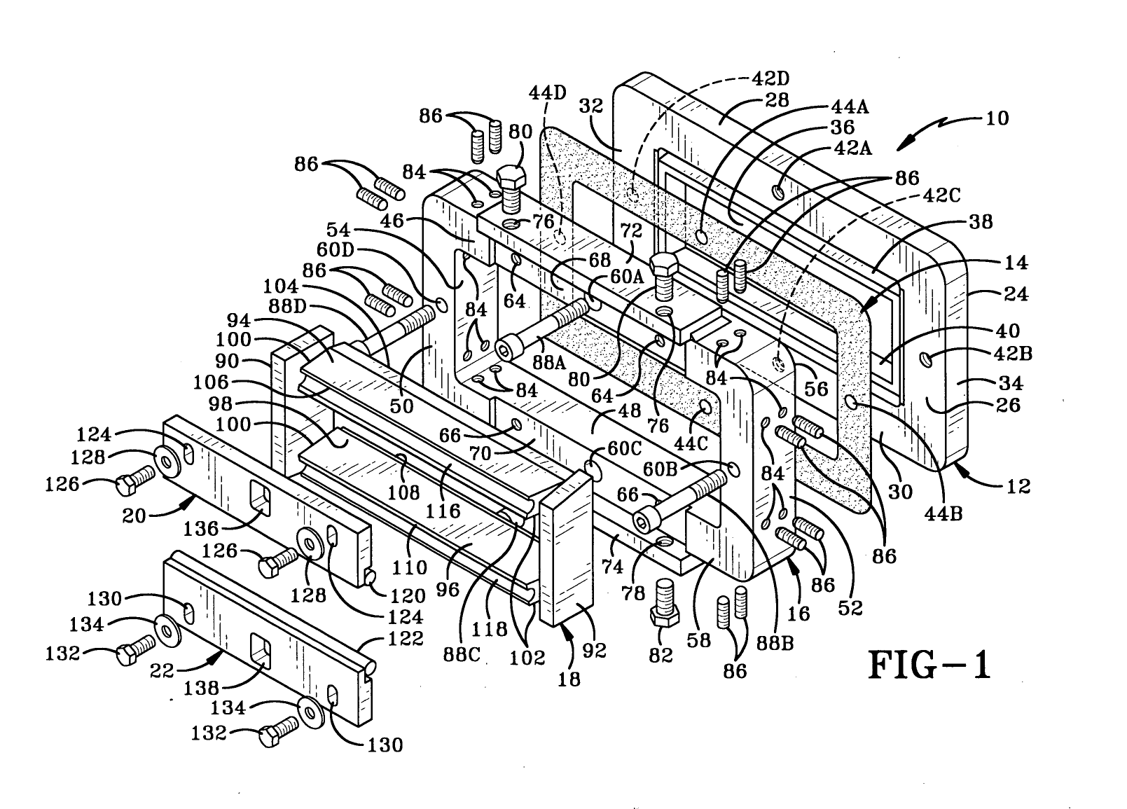

The adjustable die assembly of the present invention is shown generally at 10 in FIG. 1. Die assembly 10 is connected to the downstream end of an extruder used in the formation of ceramic bricks and thus defines the final extruded cross section of the bricks. Assembly 10 includes a rear base plate 12, a gasket 14, a front base plate 16, an adjustable die 18, an upper securing or adjusting plate 20 and lower securing or adjusting plate 22. When die assembly 10 is mounted on an extrusion apparatus for extruding bricks, rear base plate 12 is typically at the top of the die assembly with adjusting plates 20 and 22 at the bottom. However, die assembly 10 will be described herein without reference to directions as it would ordinarily be mounted. Rear base plate 12 defines the upstream end of die assembly 10 and adjusting plates 20 and 22 define the downstream end thereof. Thus, the raw brick material is extruded from base plate 12 toward adjusting plates 20 and 22.

Rear base plate 12 is substantially rectangular and has a rear surface 24 which serves as a mounting surface for contacting the extrusion apparatus to which die assembly 10 is mounted during operation. Plate 12 has an opposed front surface 26 which abuts gasket 14 when assembled. Base plate 12 includes an upper wall 28, a lower wall 30, and first and second sidewalls 32 and 34, said walls circumscribing a substantially rectangular extrusion through passage 36 extending from surface 24 to surface 26 defining an extrusion material entrance opening of assembly 10 at surface 24. An upper tapered wall 38 is mounted below top wall 28 and a lower tapered wall 40 is mounted atop lower wall 30 such that tapered walls 38 and 40 taper inwardly in the downstream direction. Four threaded holes 42A-D are formed in rear base plate 12, with hole 42A being formed in top wall 28, hole 42B in sidewall 34, hole 42C (FIG. 6) in bottom wall 30 and hole 42D formed in sidewall 32.

Gasket 14 has an upper section, a lower section and first and second side sections which correspond respectively to top wall 28, bottom wall 30 and first and second sidewalls 32 and 34 of base plate 12. Gasket 14 has a flat rear surface which abuts the flat front surface 28 of rear base plate 12 when assembled. Four holes 44A-D are formed in gasket 14 to align respectively with holes 42A-D in rear base plate 12.

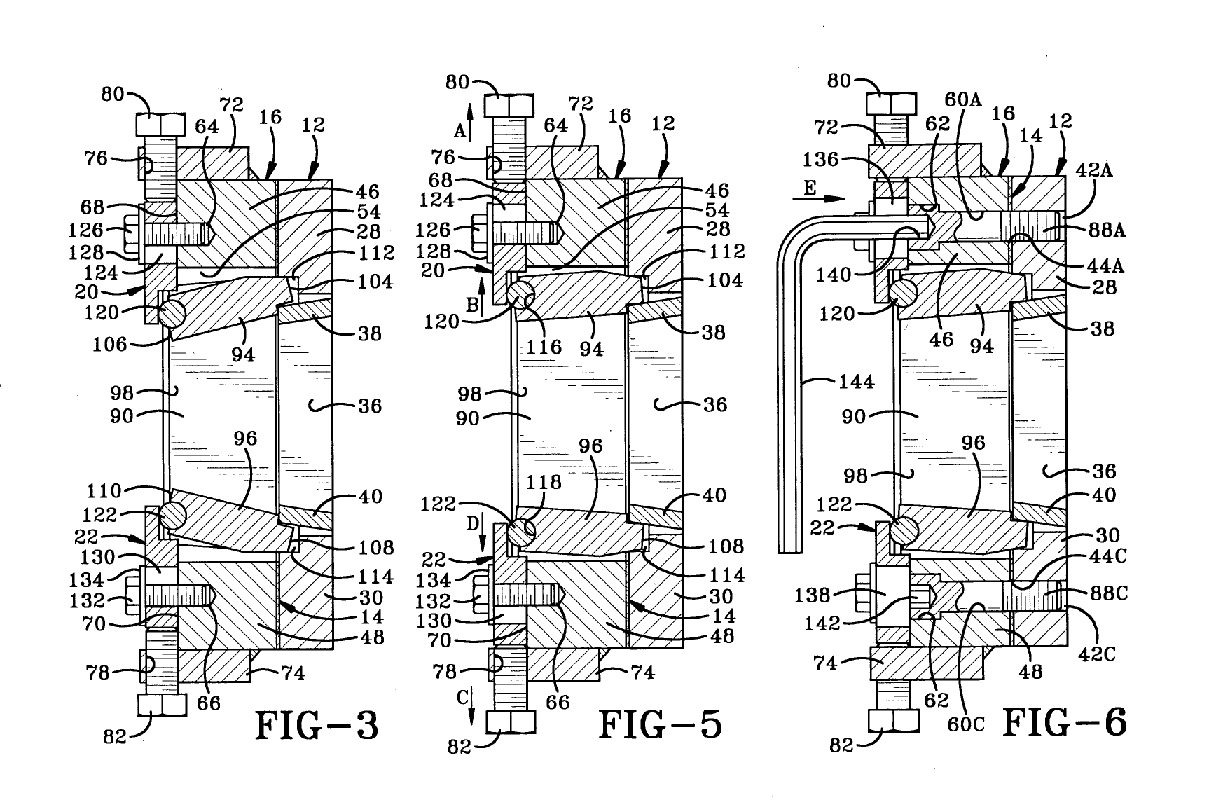

Front base plate 16 is a rectangular structure having an outer perimeter substantially the same of that of rear base 12. Front base plate 16 includes a top wall 46, a bottom wall 48 and first and second sidewalls 50 and 52 which circumscribe and define a die mounting passage 54 extending from a rear surface 56 to a front surface 58 of front base plate 16. Four non-threaded through holes 60A-D are formed in front base plate 16 extending from rear surface 56 to front surface 58. Hole 60A is formed in top wall 46, hole 60B is formed in sidewall 52, hole 60C is formed in bottom wall 48 and hole 60D is formed in sidewall 50. Each of holes 60A and 60C include an enlarged counterbore 62 (FIG. 6). A pair of threaded upper lock screw holes 64 are formed on either side of hole 60A in the top wall of 46 extending inwardly from front surface 58. More particularly, front surface 58 of top wall 46 steps inwardly to form an upper mounting channel 68 with which upper holes 64 communicate. A pair of threaded lower lock screw holes 66 is likewise formed on opposite sides of hole 60C in bottom wall 48 extending inwardly from front surface 58. Front surface 58 of lower wall 48 likewise steps inwardly to form a lower mounting channel 70 which communicates with lower holes 66. An upper flange 72 is mounted on top wall 46 and overhangs channel 68. Likewise, a lower flange 74 is mounted on bottom wall 48 and overhangs channel 70. A pair of threaded upper adjusting screw holes 76 are formed in upper flange 72 and extend from the top to the bottom thereof for threadedly receiving therein upper adjusting screws 80. Likewise, a pair of threaded lower adjusting screw holes 78 (one shown in FIG. 1, another shown in FIGS. 3 and 5) is formed in lower flange 74 extending from the top to the bottom thereof for threadedly receiving therein lower adjusting screws 82.

A plurality of threaded set screw holes 84 is formed in front base plate 16 for threadedly receiving respective set screws 86. Four mounting bolts or screws 88A-D are provided for mounting front base plate 16 to rear base plate 12 with gasket 14 sandwiched therebetween. More particularly, bolt 88A is received through hole 60A, hole 44A and threadedly engages hole 42A. Likewise, bolt 88B extends through hole 60B, hole 44B and threadedly engages hole 42B. Bolt 88C extends through hole 60C, hole 44C and threadedly engages hole 42C (FIG. 6). Bolt 88D extends through holes 60D and 44D and threadedly engages hole 42D. Enlarged heads of bolts 88A and 88C are respectively received within counterbores 62 of holes 60A and 60C so that they are flush with front surface 58 within channels 68 and 70.

Adjustable die 18 includes first and second side members in the form of substantially flat plates 90 and 92. Plates 90 and 92 angle inwardly in a downstream direction. Die 18 also includes upper and lower adjustable die plates or jaws 94 and 96. Each of plates 90 and 92 and jaws 94 and 96 define therebetween a brick forming aperture 98 or exit opening through which clay and various other raw material for forming a brick is extruded to form the final cross-sectional shape of the brick. Aperture 98 is thus substantially rectangular in shape. Aperture 98 is aligned with passage 36 for receiving therefrom the raw material being extruded. Each of jaws 94 and 96 is a generally flat plate member which is elongated between first and second ends 100 and 102 which respectively frictionally engage the inner surfaces of side plate 90 and 92. Jaws 94 and 96 are mounted between plates 90 and 92 simply by this frictional engagement. Thus, no fasteners or other structure extends from either jaw to either of plates 90 and 92. When assembled, die 18 is received within die mounting passage 54 where set screws 86 abut the upper end, lower end and outer surfaces of each plate 90 and 92 to secure die 18 therein and allow for adjustment of plates 90 and 92. Four of set screws 86 respectively engage the outer surfaces of plates 90 and 92, said outer surfaces respectively facing the inner surfaces of sidewalls 50 and 52, and apply inward forces thereon which create the above-noted frictional engagement between the jaws and plates 90 and 92. Upper jaw 94 has an upstream end 104 and a downstream end 106. Likewise, lower jaw 96 has an upstream end 108 and a downstream end 110. Upstream end 104 of upper jaw 94 is received within an upper recess 112 (FIG. 3) defined between upper wall 28 and upper tapered wall 38 so that jaw 94 abuts walls 28 and 38. Likewise, upstream end 108 of lower jaw 96 is received within a lower recess 104 defined between lower wall 30 and lower tapered wall 40 so that jaw 96 abuts walls 30 and 40. An upper groove 116 is formed in upper jaw 94 and extends inwardly from downstream end 106 and from first end 100 to second end 102 of jaw 94. Likewise, a lower groove 118 is formed in lower jaw 96 which extends inwardly from downstream end 110 and from first end 100 to second end 102 of jaw 96. Each of grooves 116 and 118 is substantially semi-cylindrical or has a semicircular cross-section.

An upper rod 120 is fixedly attached to upper adjusting plate 20 adjacent its lower end and extends in the upstream direction therefrom. Rod 120 is pivotally received within upper groove 116 when assembled. Likewise, a lower rod 122 is fixedly secured adjacent the upper end of lower adjusting plate 22 and extends in the upstream direction therefrom. Rod 122 is likewise pivotally received within lower groove 118 when assembled. A pair of elongated mounting holes 124 is formed through plate 20 and alignable with holes 64. A pair of mounting screws 126 is provided along with a respective pair of washers 128 so that screws 126 extend respectively through washers 128, holes 124 and threadedly engage holes 64 to secure plate 20 to top wall 46 abutting downstream surface 58 within upper mounting channel 68. Likewise, a pair of elongated mounting holes 130 is formed through lower plate 22 and alignable with holes 66 in bottom wall 48. Additionally, mounting screws 132 and washers 134 are provided so that screws 132 extend through washers 134 and holes 130 to threadedly engage holes 66 to secure plate 22 to bottom wall 48 abutting surface 58 within lower mounted channel 70.

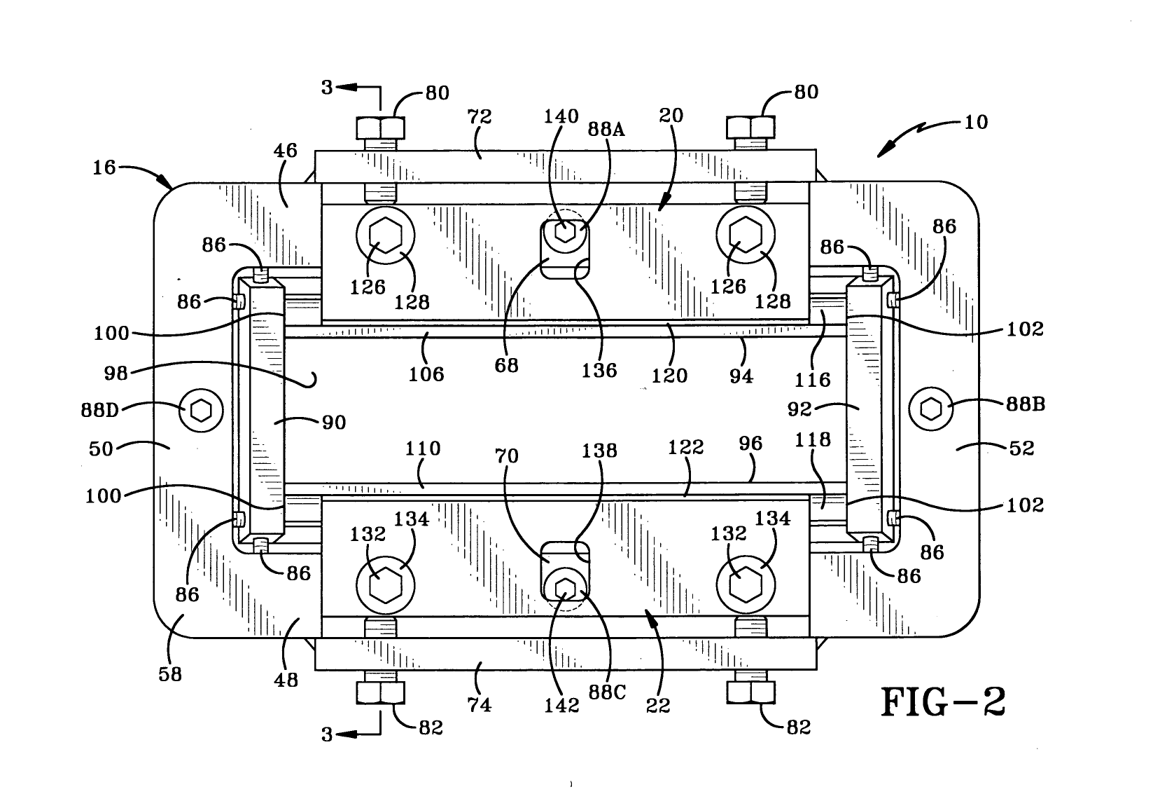

In accordance with the invention, an upper access opening 136 is formed through upper plate 20 and aligned with the head of mounting bolt 88A while a lower access opening 138 is formed through lower plate 22 and aligned with the head of mounting bolt 88C. This alignment of access openings 136 and 138 is shown in FIGS. 2, 4 and 6. Upper and lower access openings 136 and 138 thus respectively provide access to mounting bolts 88A and 88C and more particularly to respective tool-engaging formations 140 and 142 (FIG. 2) formed respectively in the heads of bolts 88A and 88C. In the embodiment shown, formations 140 and 142 are provided by the formation of a hexagonal opening configured to matingly receive an end of a hex wrench 144 (FIGS. 6-8). However, other tools may be used to engage bolts 88A and 88C such as screwdrivers, standard wrenches and so forth.

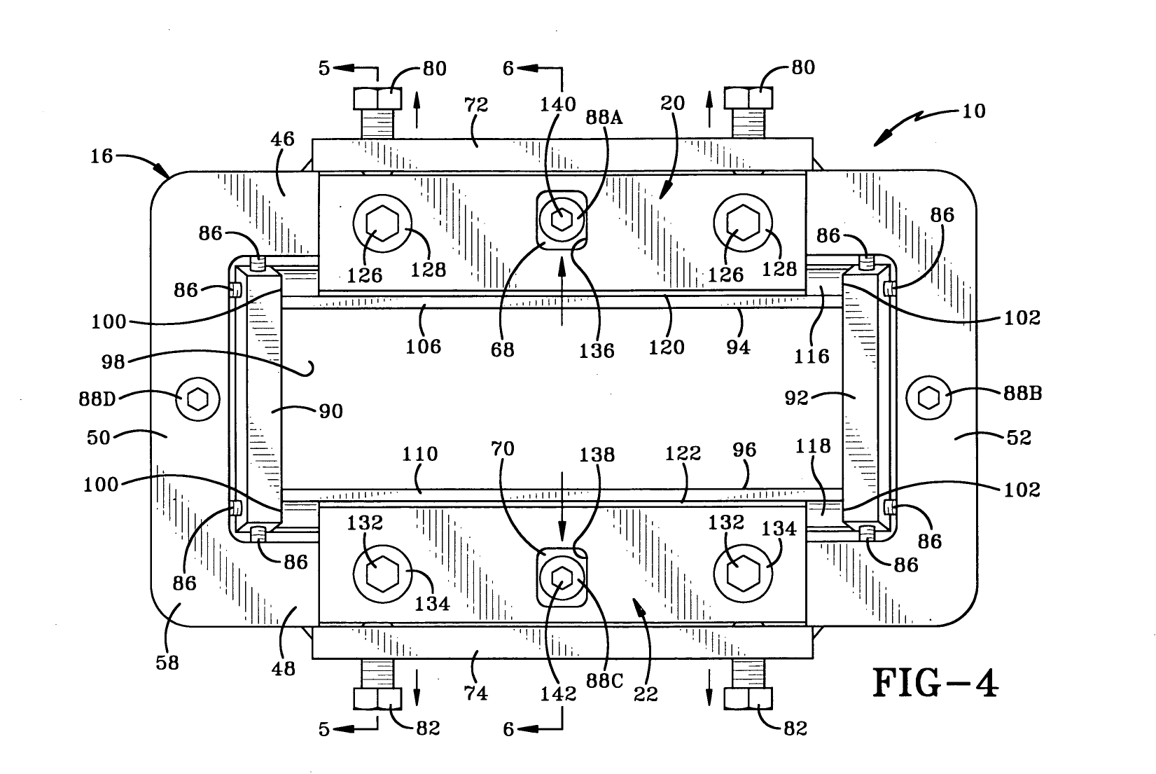

The operation of die assembly 10 is described with reference to FIGS. 2-9. Brick forming aperture 98 is adjustable by the movement of jaws 94 and 96. A narrower size aperture 98 is shown in FIGS. 2 and 3 while a wider size aperture is shown in FIGS. 4-9. The width or size of aperture 98 is controlled by the movement of adjusting plates 20 and 22, which move jaws 94 and 96 respectively via the pivotal engagement of rod 120 within groove 116 and rod 122 within groove 118. Plate 20 is adjusted by the rotation of upper adjusting screws 80, which engage the upper surface of plate 20. In order to make this adjustment, mounting or locking screws 126 are first loosened so that plate 20 may move up and down with the shafts of screws 126 disposed in the elongated holes 124 in response to rotation of adjusting screws 80. Adjusting plate 22 is adjusted in the same manner by loosening the locking screws 132 and rotating adjusting screws 82 in order to move or allow the movement of plate 22 with the shafts of screws 132 within the elongated holes 130. The upward movement of screw 80 and plate 20 is indicated respectively at Arrows A and B in FIG. 5. Likewise, the downward movement of screws 82 and plate 22 is shown respectively at Arrows C and D in FIG. 5. The upward movement of plate 20 causes jaw 94 to move upwardly via the engagement between rod 120 and jaw 94 within groove 116. Likewise, the downward movement of plate 22 causes the downward movement of jaw 96 via the engagement of rod 122 with jaw 96 within groove 118. Jaws 94 and 96 during this movement pivot respectively within upper and lower recesses 112 and 114.

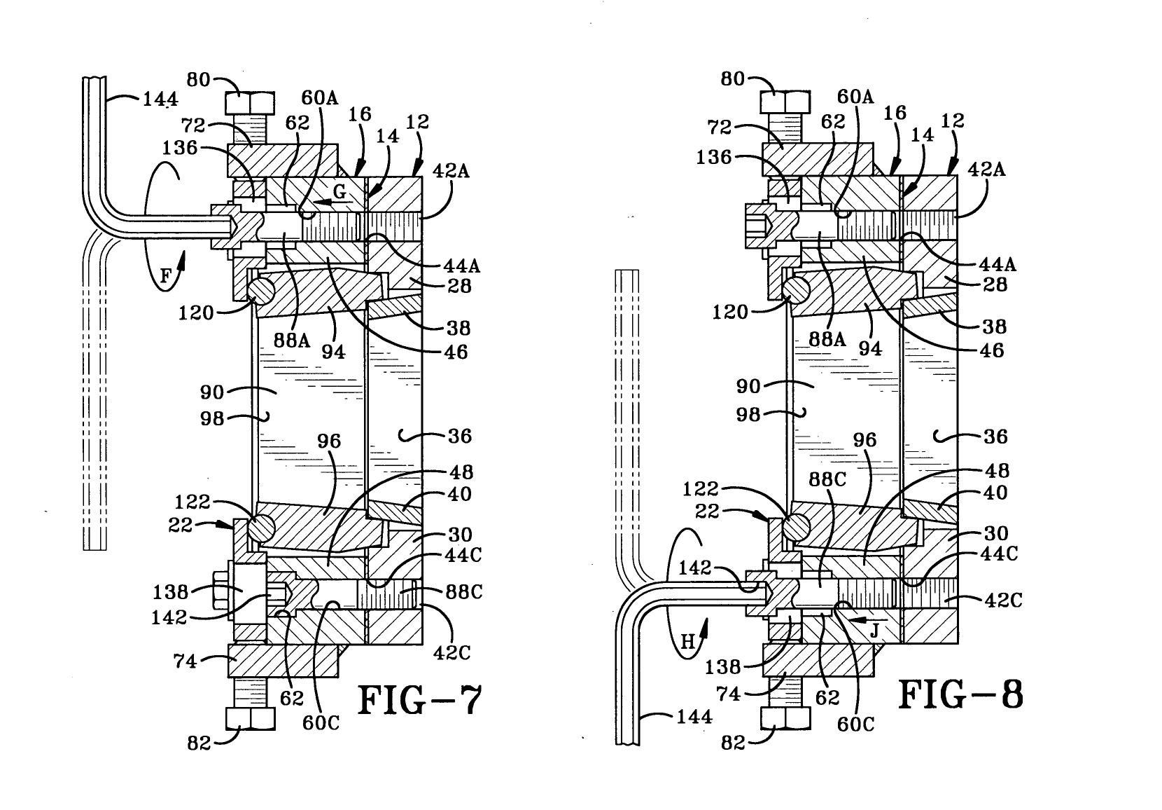

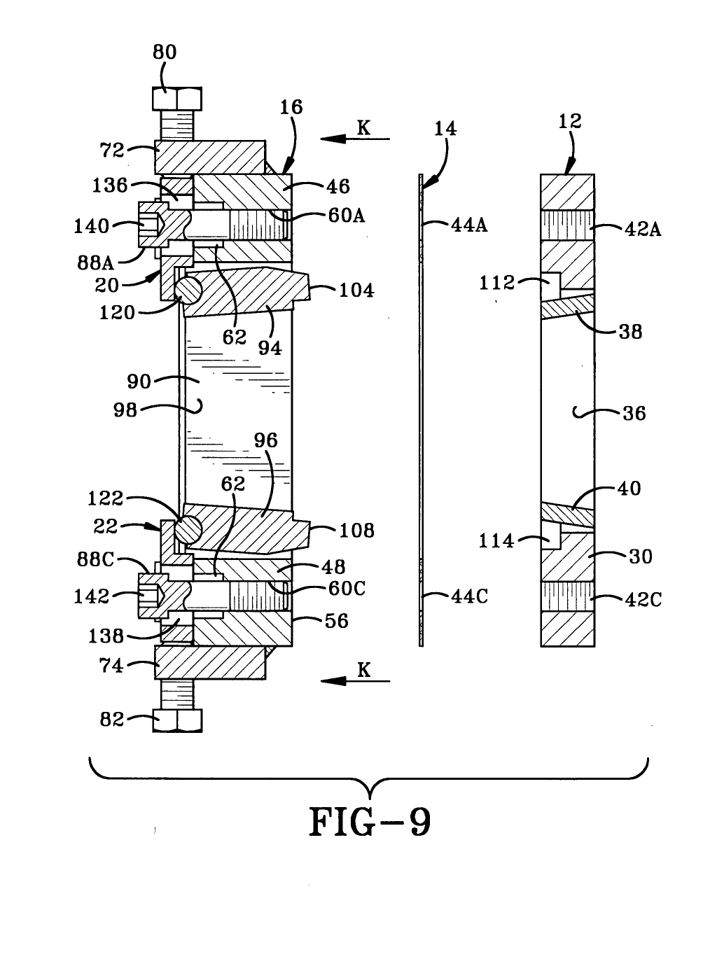

In order to access gasket 14 for its replacement, front base plate 16 must be removed from rear base plate 12. The removal of plate 16 from plate 12 may be required for other purposes as well. As previously noted, once die 18 has been set to define the desired size aperture 98 for extrusion of a specific brick-forming extrusion material and associated brick, it is undesirable to alter the size of aperture 98 while that material is being used to form the given type of brick. Thus, in accordance with the invention, access openings 136 and 138 allow for the separation of plates 16 and 12 without altering aperture 98. Thus, plates 16 and 12 may be separated without altering the position of jaws 94 and 96 or plates 20 and 22 relative to front base plate 16. Referring to FIG. 6, an end of hex wrench 144 is inserted into hex opening 140 as indicated at Arrow E to engage the head of bolt 88A. FIG. 7 shows hex wrench 144 rotating to rotate bolt 88A shown at FIG. F in order to unthread bolt 88A from threaded hole 42A to remove bolt 88A therefrom as indicated at Arrow G. Similarly, FIG. 8 shows hex wrench 144 rotating bolt 88C as shown at Arrow H to loosen and remove bolt 88C from threaded hole 42C, as indicated at Arrow J. Bolts 88B and 88D are likewise removed respectively from holes 42B and 42D in the same manner although no access opening is required. Once all of bolts 88 are removed from the respective threaded holes 42, front base plate 16 may be removed from gasket 14 and rear base plate 12 as shown in FIG. 9 at Arrows K so that gasket 14 may be removed and replaced or other maintenance may be performed as needed. As bolts 88A and 88C are unthreaded and removed respectively from holes 42A and 42C, the heads of bolts 88A and 88C move in the downstream direction out of respective counterbores 62 and into respective access openings 136 and 138. Both 88A and 88C may be entirely withdrawn through access openings 136 and 138 respectively if desired. Once gasket 14 has been removed or other maintenance has been performed, base plates 16 and 12 may be reconnected by reversing the steps described for removal, once again without varying the size of aperture 98.

It is noted that front base plate 16 may be removed from rear base plate 12 when die assembly 10 is in the configuration shown in FIGS. 2 and 3 with the narrower aperture 98. However, while in the configuration shown in FIG. 2, plates 20 and 22 will respectively prevent bolts 88A and 88C from moving out of respective holes 60A and 60C and into access openings 136 and 138. Thus, in order to remove front plate 16 from rear plate 12 while in the configuration of FIG. 2, bolts 88B and 88D must be unthreaded prior to the unthreading of bolts 88A and 88C. While this process would be somewhat more painstaking, nonetheless it is possible to remove plate 16 from plate 12 while in a configuration such as that shown in FIG. 2 without altering the size of aperture 98.

Thus, die assembly 10 is connected at the end of an extruder which extrudes ceramic brick-forming material through passage 36, the opening formed in gasket 14 and aperture 98, which produces the final cross-sectional shape of the extruded brick material. This raw material will ultimately be fired to produce various types of bricks. Assembly 10 thus allows the extruding process to be stopped for a relative short period in order to remove and replace gasket 14 or perform other maintenance needed without varying the size of aperture 98. The die assembly can then be reassembled without changing aperture 98 so that the same extrusion material may be extruded through aperture 98 to produce the same bricks without having to go through a painstaking adjustment process in order to position jaws 94 and 96 in exactly the right location. This process is particularly tricky in the brick making industry, typically involving a series of trial and error adjustments. The ability to remove the adjustable die without changing the aperture thereof also allows for the option of maintaining more than one adjustable die which have respectively been adjusted through such trial and error processes for respectively producing specific bricks associated therewith. Thus, one adjustable die may be removed and another put in its place in order to change the production from one material brick type to another material and brick type.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. An adjustable die assembly for extruding brick-forming material therethrough, the assembly comprising:
a first base plate;
a hole formed in the first base plate;
a fastener in the hole;
a through passage formed in the first base plate;
an adjustable die adjacent the passage;
a brick-forming extrusion aperture formed in the die and adapted for defining a cross sectional shape of ceramic brick-forming material extruded therethrough;
an adjustable jaw on the die bounding the aperture and movable to a plurality of positions to adjust the size of the aperture;
a securing member for selectively securing the jaw at a first one of the positions to set the size of the aperture; and
an access opening formed through the securing member for accessing the fastener.

2. The assembly of claim 1 wherein the securing member serves as an adjusting member operatively connected to the jaw for moving the jaw to the plurality of positions.

3. The assembly of claim 2 wherein the adjusting member is pivotally mounted on the jaw.

4. The assembly of claim 3 further comprising a groove formed in one of the adjusting member and jaw; and a rod on the other of the adjusting member and jaw pivotally received in the groove.

5. The assembly of claim 2 further comprising at least one locking screw for securing the adjusting member.

6. The assembly of claim 5 further comprising at least one adjusting screw for moving the adjusting member.

7. The assembly of claim 1 further comprising first and second spaced side plates on the die bounding the aperture; and wherein the jaw is between the first and second side plates.

8. The assembly of claim 7 further comprising a first frictional engagement between the first side plate and the jaw; and a second frictional engagement between the second side plate and the jaw; said frictional engagements holding the jaw in place between the first and second side plates without fasteners extending from the jaw to either of the side plates.

9. The assembly of claim 1 further comprising an outer surface on the first base plate; wherein the hole extends inwardly from the outer surface; and the securing member abuts the outer surface adjacent the hole.

10. The assembly of claim 9 further comprising a threaded lock screw hole formed in the first base plate; a hole formed in the securing member; and a lock screw extending respectively through the hole in the securing member and threadedly engaging the first base plate respectively within the lock screw hole for selectively securing the securing member to the first base plate.

11. The assembly of claim 10 wherein the securing member serves as an adjusting member operatively connected to the jaw for moving the jaw to the plurality of positions; and the hole in the securing member is elongated; and further comprising an adjusting screw threadedly engaging the first base plate for moving the securing member relative to the first base plate with the lock screw disposed in the elongated hole.

12. The assembly of claim 1 further comprising a second base plate removably mounted on the first base plate by the fastener; and wherein the die is mounted on one of the first and second base plates; and the second base plate is removable from the first base plate without moving the jaw out of the first position.

13. The assembly of claim 12 wherein the hole is a threaded hole; the fastener threadedly engages the first base plate within the threaded hole; and the die is mounted on the second base plate.

14. The assembly of claim 13 further comprising a tool-engaging formation on the fastener aligned with the access opening and adapted to be engaged by a tool for loosening the fastener.

15. The assembly of claim 13 further comprising a hole formed in the second base plate through which the fastener extends.

16. The assembly of claim 12 wherein the die is disposed in the through passage and engages the second base plate.

17. The assembly of claim 12 further comprising a gasket between the first and second base plates.

18. The assembly of claim 1 further comprising threaded second and third holes formed in the first base plate; and first and second lock screws threadedly engaging the first base plate respectively within the second and third holes for selectively securing the securing member to the first base plate; and wherein the access opening is between the lock screws.

19. An adjustable die assembly for extruding brick material therethrough, the assembly comprising:
a base plate;
first and second threaded holes formed in the base plate;
a third hole formed in the base plate between the first and second threaded holes;
a fastener in the third hole;
an adjustable die mounted on the base plate;
a brick-forming extrusion aperture formed in the die and adapted for defining a cross sectional shape of ceramic brick-forming material extruded therethrough;
an adjustable jaw on the die bounding the aperture and movable to a plurality of positions to adjust the size of the aperture;
first and second lock screws threadedly engaging the base plate respectively within the first and second threaded holes for selectively securing the jaw at a first one of the positions to set the size of the aperture; and
an access opening between the lock screws for accessing the fastener.

20. A method comprising the steps of:
inserting a tool through an access opening formed through a securing member which secures an adjustable jaw bounding a ceramic brick-forming extrusion aperture formed in a die to engage a fastener with the tool; and
loosening the fastener with the tool to remove the die from a first base plate without changing the size of the aperture.
